(19) United States
(12) Patent Application Publication
(10) Pub. No.: US 2010/0136229 A1
(43) Pub. Date: Jun. 3, 2010

(54) WARM SPRAY COATING METHOD AND PARTICLES USED THEREFOR

(75) Inventors: Jin Kawakita, Ibaraki (JP); Seiji Kuroda, Ibaraki (JP)

Correspondence Address: WENDEROTH, LIND & PONACK, L.L.P., 1030 15th Street, N.W.,, Suite 400 East, Washington, DC, 20005-1503, US

(73) Assignee: National Institute for Materials Science

(21) Appl. No.: 12/448,067

(22) PCT Filed: Sep. 14, 2007
(86) PCT No.: PCT/JP2007/067998

§ 371 Date: Dec. 28, 2009

(30) Foreign Application Priority Data
Dec. 7, 2006 (JP) 2006-330067
Mar. 13, 2007 (JP) 2007-062821

(51) Int. Cl. C23C 24/04; B32B 5/16

(52) U.S. Cl. 427/180; 428/402

(57) ABSTRACT

A coating method of the invention is characterized by using particles each being an aggregate comprising particles far smaller than that, and heating them at a temperature lower than the melting point and blowing and depositing the same to an object to be treated at a supersonic velocity. The warm spray of the invention is characterized in that standard particles and addition particles with a particle diameter larger than that are mixed so that the K-value determined by the following relation is 1 or more and 2 or less: K=A×(B/C)×D, A: mass % of the content of additive particles, B: center particle diameter of standard particle (μm), C: center particle diameter of additive particle (μm), D: (maximum particle diameter−minimum particle diameter) of additive particle/10 (μm). The invention intends to deposit micro oxide crystals without using an adhesive or the like, with no alteration to the function thereof, and also attain a dense layer with no substantial voids.

### TECHNICAL FIELD

The present invention concerns a warm spray coating method of depositing particles to the surface of an object to be treated and particles used therefor.

### BACKGROUND ART

As a method of depositing material particles having various functions to the surface of an object to be treated, a method of interposing an adhesive, a method of coating in the form of a paint, etc. have been known as typical methods. However, in the methods described above, functional material particles are eventually covered by the adhesive, for example, to result in hindrance of the function at the surface thereof.

Particularly, a catalyst or the like can provide the function efficiently by making the particles of crystal finer as the material particle, but most of them are buried in the adhesive to bring about a problem of causing functional failure in the existent methods described above.

Accordingly, it has been demanded for technical means capable of depositing fine material particles, for example, oxide crystals with no alteration for the function thereof, without using the adhesive or the like.

On the other hand, as a method of depositing various kinds of material particles to the surface of an object to be treated, a warm spray method of heating particles to a temperature lower than the melting point thereof and depositing them by blowing at a supersonic velocity has been known. According to the warm spray method of the type described above, since the modification of the surface of the object to be treated can be completed by blowing and depositing the particles to the objective, the method has attracted attention due to the superiority in view of various operations, for example, that modification operation can be attained in the field.

Then, also for the deposition of the functional material particles, it may be considered to apply a coating method by the warm spray. However, deposition of the particles by the warm spray method with no alteration in the functionality has not been considered in view of the possibility thereof. Further, also the measure for specifically realizing the same has not yet been studied.

Further, as the specific subject of the coating method by warm spray, voids tend to be formed in a case of blowing particles and, accordingly, a device has been made for decreasing the particle diameter as small as possible. However, it has been found that restriction is imposed on the fineness of the particle diameter due to a jet pressure upon spraying.

Accordingly, it has been also demanded for attaining technical means of overcoming restriction on the particle diameter and forming a dense layer with no substantial voids.

### DISCLOSURE OF THE INVENTION

### Subject to be Solved by the Invention

With the background as described above, the present invention has a subject of overcoming the restriction in view of the problem in the prior art and providing new technical means capable of depositing functional material particles to the surface of an object to be treated with no substantial alteration in the functionality and, particularly, realizing the same by the warm spray method, and capable of attaining a dense layer with no substantial voids by the warm spray method while overcoming the restriction on the particle diameter.

### Means for Solving the Subject

For attaining the subject described above, the invention has the following features. The warm spray coating method according to an invention 1 is characterized in that a particle is an aggregate of fine particles with a particle diameter smaller than that of the particle, and heated to a temperature lower than the phase transition temperature thereof and blown and deposited at a supersonic velocity to an object to be treated.

An invention 2 according to the coating method of the invention 1 is characterized in that the particle is formed by aggregating and solidifying micro particles to each other by a binder comprising an organic compound and in that the heating temperature upon blowing is at or higher than the sublimation temperature of the binder.

An invention 3 according to the coating method of invention 1 or 2 is characterized in that the micro particle comprises an oxide crystal.

Then, an invention 4 to an invention 6 are characterized by the warm spray coating particle per se according to the invention 1 to the invention 3.

Further, the warm spray coating method according to an invention 7 is characterized by using standard particles and additive particles with the particle diameter larger than that and mixing and blowing them such that a K value which is determined according to the following relation is 1 or more and 2 or less.

K=A×(B/C)×D

A: mass % of the content of additive particles

B: center particle diameter of standard particle (μm)

C: center particle diameter of additive particle (μm)

D: (maximum particle diameter−minimum particle diameter) of additive particle/10 (μm)

An invention 8 is a warm spray method according to invention 7 characterized in that both the standard particle and the additive particle are formed of an identical kind of metal particles.

The method according to an invention 9 is characterized in that at least one of the standard particle and the additive particle is an aggregate of fine particles with the diameter smaller than that of the particle diameter of each of them.

The method according to an invention 10 is characterized in that the fine particle constituting the aggregate in the invention 9 comprises an oxide crystal.

Further, an invention 11 to an invention 14 is characterized by the particle per se for warm spray coating according to the invention 7 to the invention 10.

### EFFECT OF THE INVENTION

The method according to inventions 1 to 6 belong to a novel warm spray method. Heretofore, the minimum value for the particle diameter of the particle that can be blown is restricted and it is considered that blowing at a supersonic velocity is impossible above the minimum value.

However, according to the present invention, even a fine particle of less than the sub-micron size which is out of the restriction of the minimum limit can also be blown and deposited to an object to be treated.

Further, since the binder is sublimated or vaporized during flying, this can avoid that the fine particles are covered by the adhesive failing to provide the function thereof as in the usual case.

Further, the crystal in a fine particulate form can be deposited with no denaturation and the function thereof can be maximized on the surface of an object to be treated.

Further, according to the inventions 7 to 14, a remarkably dense layer (film) is formed. Addition per se of a slight amount of large sized particles which was avoided as deteriorating the denseness can not be expected at all in view of the existent technical common knowledge and, further, this results in an effect quite contrary to the existent technical common knowledge.

### BRIEF EXPLANATION OF DRAWINGS

FIG. 1 is a schematic view showing the structure of a spray apparatus used in the present method.

FIG. 2 is a microscopic photograph for a particle used in Experiment No. 2 of Example A.

FIG. 3 is an enlarged photograph for the cross section of the particle shown in FIG. 2.

FIG. 4 is an enlarged photograph for the surface of a coating layer in an example.

FIG. 5 is an enlarged photograph for the side elevation of the coating layer shown in FIG. 4.

FIG. 6 is an enlarged photograph enlarging a portion of FIG. 5.

FIG. 7 is a photograph for the cross section of a coating layer according to Experiment No. 1.

FIG. 8 is an enlarged photograph by 4× for the cross section of the coating layer according to Experiment No. 1.

FIG. 9 is a photograph showing the result of a salt water immersion test for a sample in Experiment No. 1.

FIG. 10 is an photograph for the cross section of a coating layer according to Experiment No. 2.

FIG. 11 is an enlarged photograph by 4× for the cross section of the coating layer according to Experiment No. 2.

FIG. 12 is a photograph showing the result of a salt water immersion test for a sample in Experiment No. 2.

FIG. 13 is a photograph for the cross section of a coating layer according to Experiment No. 3.

FIG. 14 is an enlarged photograph by 4× for the cross section of the coating layer according to Experiment No. 3.

FIG. 15 is a photograph showing the result of a salt water immersion test for a sample in Experiment No. 3.

FIG. 16 is an photograph for the cross section of a coating layer according to Experiment No. 4.

FIG. 17 is an enlarged photograph by 4× for the cross section of the coating layer according to Experiment No. 4.

FIG. 18 is a photograph showing the result of a salt water immersion test for a sample in Experiment No. 4.

FIG. 19 is a photograph for the cross section of a coating layer according to Experiment No. 5.

FIG. 20 is an enlarged photograph by 4× for the cross section of the coating layer according to Experiment No. 5.

FIG. 21 is a photograph showing the result of a salt water immersion test for a sample in Experiment No. 5.

FIG. 22 is a photograph for the cross section of a coating layer according to Experiment No. 6.

FIG. 23 is an enlarged photograph by 4× for the cross section of the coating layer according to Experiment No. 6.

FIG. 24 is a photograph showing the result of a salt water immersion test for a sample in Experiment No. 6.

FIG. 25 is a photograph for the cross section of a coating layer according to Experiment No. 7.

FIG. 26 is an enlarged photograph by 4× for the cross section of the coating layer according to Experiment No. 7.

FIG. 27 is a photograph showing the result of a salt water immersion test for a sample in Experiment No. 7.

FIG. 28 is a photograph for the cross section of a coating layer according to Experiment No. 8.

FIG. 29 is an enlarged photograph by 4× for the cross section of the coating layer according to Experiment No. 8.

FIG. 30 is a photograph showing the result of a salt water immersion test for a sample in Experiment No. 8.

FIG. 31 is a photograph for the cross section of a coating layer according to Experiment No. 9.

FIG. 32 is an enlarged photograph by 4× for the cross section of the coating layer according to Experiment No. 9.

FIG. 33 is a photograph showing the result of a salt water immersion test for a sample in Experiment No. 9.

FIG. 34 is a photograph for the cross section of a coating layer according to Experiment No. 10.

FIG. 35 is an enlarged photograph by 4× for the cross section of the coating layer according to Experiment No. 10.

FIG. 36 is a photograph showing the result of a salt water immersion test for a sample in Experiment No. 10.

FIG. 37 is a photograph for the cross section of a coating layer according to Experiment No. 11.

FIG. 38 is an enlarged photograph by 4× for the cross section of the coating layer according to Experiment No. 11.

FIG. 39 is a photograph showing the result of a salt water immersion test for a sample in Experiment No. 11.

FIG. 40 is a photograph for the cross section of a coating layer according to Experiment No. 12.

FIG. 41 is an enlarged photograph by 4× for the cross section of the coating layer according to Experiment No. 12.

FIG. 42 is a photograph showing the result of a salt water immersion test for a sample in Experiment No. 12.

### DESCRIPTION FOR REFERENCES

(1) combustion chamber
(2) fuel supply port
(3) oxygen supply port
(4) nozzle
(5) inert gas supply port
(6) barrel
(7) particle charging port
(8) objective to be treated

### BEST MODE FOR CARRYING OUT THE INVENTION

The invention 1 to the invention 6 described above concern a warm spray coating method using particles each comprising an aggregate of fine particles of smaller particle diameter, and the particle therefor. The warm spray coating method in this case includes, as fundamental constitutional factors;

<1> using an aggregate of a fine particle comprising fine particles of smaller particle diameter, for example, fine particles of oxide crystals, metals, alloys, and ceramics, as the particle used for spraying, and

<2> heating the same to a temperature lower than the phase transition temperature of the particle, as described above. In the warm spring coating of the invention, the particles described above are blown at a supersonic velocity to an object to be treated.

For the constitutional factor <1>, the particle diameter for the fine particle and the aggregate thereof may be optional and can be set corresponding to the purpose, the application use, and the function of an object to be treated, that is, a substrate or a film blown to the substrate, as well as the scale of the apparatus and the operation conditions for warm spray.

For example, an aggregate particle may have a particle diameter which is larger by 10 times to 1000 times than the particle diameter of fine particle. For example, it is considered as a measure to form an aggregate particle having a particle diameter of 10 μm to 100 μm from fine particles having a particle diameter of 10 to 1000 nm.

The particles as the aggregate can be controlled within a range of required particle diameter by using a device such as a vibration sieve. There may be various methods for forming aggregates of fine particles. For example, a binder of an organic compound or inorganic material may be used, or it may be optionally considered a method of forming an aggregate by electrostatic attraction and then effecting firing, etc.

As a method capable of forming the aggregate simply and conveniently, easy to be handle with, and giving no substantial effects on the blown film, a method of using a binder of an organic compound is considered appropriate. In this case, the sublimation temperature or vaporization temperature of the organic compound as the binder is preferably at or lower than the heating temperature upon warm spray.

For the organic compound as the binder, it may be considered to use, for example, various types of synthetic polymeric binders such as polyvinyl alcohol (PVA), as well as, acrylic type, polyester type or polyurethane type, or natural or semi-synthetic binder comprising starch or the like, while considering easy availability and handlability or cost.

The amount of use of the binder may be such that the aggregate comprising the fine particles can be formed and the particle shape can be retained upon supply thereof to the form spray apparatus means. The amount may be a minimum amount. The aggregate can be formed by usual means of mixing the fine particles with the binder described above and pelleting them by heating or drying. In this case, a spray-dry method or the like may be adopted optionally.

The definition of “lower than phase transition temperature” for the heating temperature of the constitutional factor <2> means that it is lower than “phase transition temperature” defined as a temperature upon transition from thermodynamic low temperature stable phase to high temperature stable phase. For example, in a case of titanium oxide used also in the example to be described later, “phase transition temperature” is 1000 k or higher.

For the heating at “lower than the phase transition temperature”, since the staying time of the particles as a target in the jet of the warm spray is usually as short as 1 ms or less, even when the jet temperature is above “phase transition temperature” as the measured value, it is sometimes judged that the heating temperature for the particle does not reach “phase transition temperature”.

For the judgment described above, specific heat or heat conductivity of the particle may be taken into consideration.

From the foregoings, in a case of titanium oxide, for example, it is actually considered that the measuring value for the jet temperature is defined as lower than 1600 k.

The outline for the warm spray method itself has already been known and the invention can be practiced based on such known knowledge.

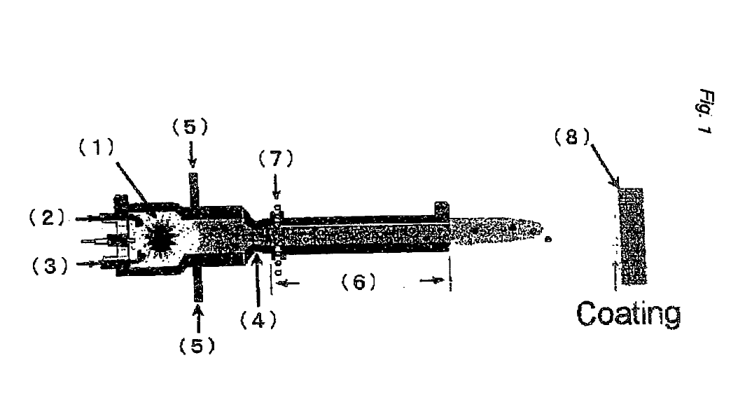

For example, FIG. 1 shows an outline of a warm spray gun used in practicing the invention, which has a fuel supply port (2) and an oxygen supply port (3) for entering fuel and oxygen under pressure into a combustion chamber (1), in which a port (5) for supplying an inert gas to the combustion chamber (1) is disposed near a nozzle (4), which is the exit of the combustion chamber (1). As described above, it is adapted such that the amount of supply of oxygen and fuel is increased or decreased in an inverse proportion to the increase and decrease of the inert gas upon enter under pressure, and the temperature can be controlled within a range from 4×10² to 25×10²° C. while keeping the gas jetting speed from the nozzle (4) so as not to fluctuate the same so much.

Further, a cylindrical barrel (6) is connected coaxially to the exit of the nozzle (4) and a charging port (7) for charging particles is disposed near the end of the nozzle.

For example, it is considered to effect blowing at a supersonic velocity suitably under the condition that the colliding speed to an object to be treated is from 500 to 1300 m/s in the case of the invention by using the apparatus described above.

The colliding speed can be calculated as a fluid dynamic simulation and the speed can be attained by the control for the jetting speed of the spray jet and the distance between the exit of the spray nozzle and the object to be treated.

The warm spray coating at a supersonic velocity can be attained.

According to the inventions 1 to 6, a functional film can be formed by warm spray using particles as an aggregate without substantially deteriorating the functionality of fine particles thereof.

Further, the warm spray method and the particles used therefor in the present inventions 7 to 14 include, as fundamental constitutional factors that particles comprise;

<1> standard particle, and
<2> additive particle with a diameter greater than that of the standard particle, as the particle and
using both of the particles in admixture within such an inherent range that the K value determined according to the relation as described above is 1 or more and 2 or less. A dense film can thus be formed easily.

“Standard particle” referred to herein may be particles of a particle diameter usually used for the flame spray method and easily available as commercial products. For example, in a case of titanium oxide, this may be considered that it comprises a particle with particle diameter of 45 μm or less.

“Additive particle”, on the other side, is defined as having such a large particle diameter that is not used usually.

By mixing the additive particles of larger grain to the standard particles at an inherent ratio, that is, by mixing them so as to obtain a K value of 1 or more and 2 or less, the denseness of the film is improved remarkably compared with a case of using only the standard particles.

For the denseness of the film, it is evaluated that the denseness is high when the porosity P is low. As a method of measuring the porosity P, there is a method of packing mercury in pores and measuring the amount thereof. Alternatively, since it has been known that the porosity P is concerned with a value Rc by an electrochemical method (corrosion resistance), the Rc value used also in the examples to be described later may be used as a measure for the porosity (denseness).

In the mixing of the standard particles and the additive particles, while they may be of kinds different from each other, it is preferred to use identical kind of particles, for example, metal particles of an identical kind with a view point of remarkable improvement of the denseness.

Further, a composite functionality may be attained together with improvement in the denseness by using plural kinds of additive particles to one kind of standard particle. Alternatively, it may also be considered that the standard particle comprises plural types and the additive particle comprises a single type or plural types.

Then, upon mixing described above, at least one of the standard particle and the additive particle may be an aggregate of fine particles with the diameter being smaller than that of each of the particles in the same manner as in the inventions 1 to 6. According to this, the denseness is improved and the functionality of the fine particle can be provided for the film with no substantial deterioration.

Also in the inventions 7 to 14, a warm spray apparatus having the constitution, for example, of FIG. 1 can be used. In the apparatus, it is preferred, for example, to control the oxygen concentration to 5 vol % or less in the gas during supply of the powder mixture and the gas temperature to 1500° C. or lower in a case of the metal particle, etc. Such temperature control can be effected by mixing an inert gas into a combustion gas.

Further, the colliding speed of the particle mixture to the object to be treated is preferably from 500 to 1300 m/s in the same manner as in the case of the inventions 1 to 6.

While the examples to be described later show the case of the Ti particle, this is not restrictive. In a case where the oxygen concentration exceeds 5 vol %, the gas temperature exceeds 1500° C., or the colliding speed is less than 500 m/s, it is difficult, for example, to suppress oxidation of Ti or obtain a dense structure. On the other hand, the lower limit of the oxygen concentration is desirably as low as possible as the oxygen content ratio after the combustion reaction of forming a high speed flame. The gas temperature dominates the heating state and the flow rate of particles, for example, of the Ti metal or alloy thereof. The lower limit varies, for example, depending on the scale of the apparatus, the amount of the powder to be supplied, the type of the powder, for example, metals such as Ti, as well as Mn, Sn, Zn, Mo, Ga, In, W, Al, Cu, Ta, Hf, Nb, Sb, V, Fe, Ni, Co, Rh, Pt, or alloys comprising two or more of them, or one or more of oxides of such metals, or composite ceramic oxides, and it is generally 900° C. or higher as a measure. While considering the foregoings, the amount of supply and the supply speed of the inert gas are determined also considering the scale of the apparatus, etc. in actual operation.

For the kind of the inert gas, for example, N₂ (nitrogen gas), or a rare gas such as Ar (argon) or He (helium) is typically shown suitably. Further, other gas such as CO₂ may also be used depending on the condition.

Then, examples are to be shown below and description is to be made more specifically. It will be apparent that the invention is not restricted by the following examples.

### EXAMPLES

### Example A

PVA (polyvinyl alcohol) was used as the binder and warm spray coating was effected by using aggregate particles of fine particles of each of titanium oxide and iron oxide.

Examples of coating various kinds of materials using the apparatus shown in FIG. 1 in this case are shown in Table 1 and Table 2.

At the temperature of the jet in Table 2, the heating temperature for the particle of titanium oxide and iron oxide per se is lower than the phase transition temperature for each of them.

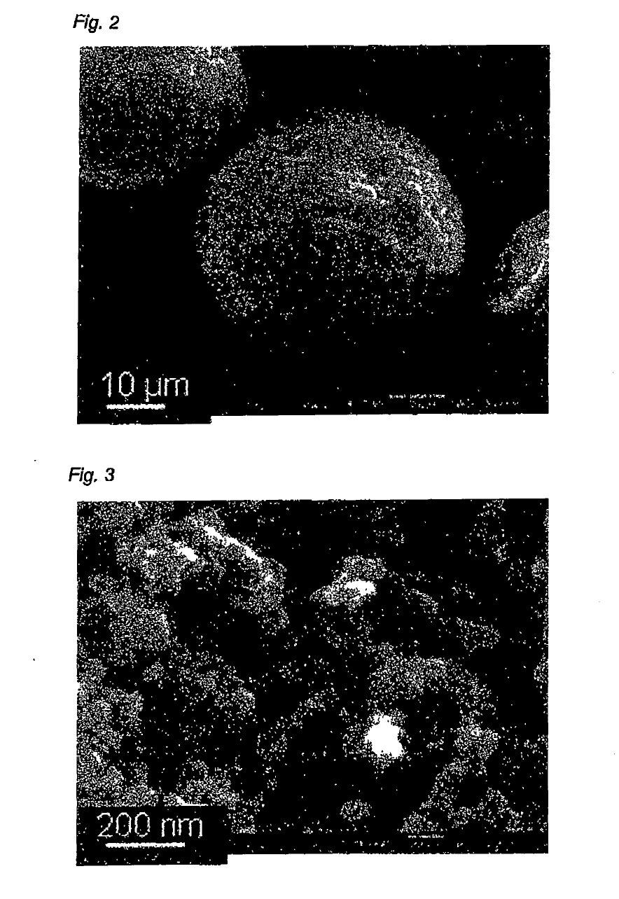

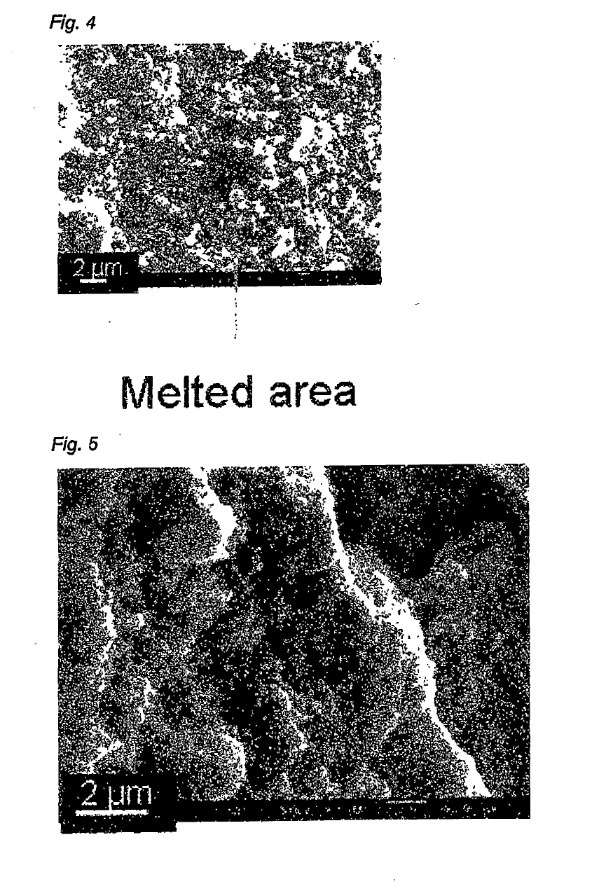

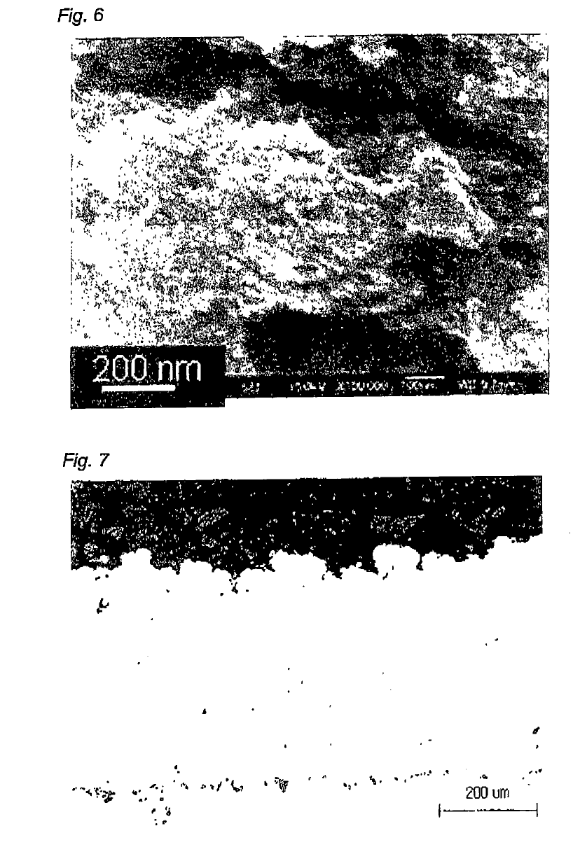

FIG. 2 to FIG. 6 are enlarged photographs relevant to Experiment No. 2.

Since similar appearance is shown also in other experimental examples, photographs showing them are omitted.

It has been confirmed that binders are not restricted to PVA but binders known generally so far such as acrylic type, polyester type, polyurethane type or the like can also be used. Further, use of a natural or semi-synthetic binder comprising starch may also be used.

TABLE 1

| | Fine particles | | Particles | | |
|---|---|---|---|---|---|
| Experiment | | Main | Particle | Particle | |
| No. | Material | function | diameter nm | diameter nm | Binder |
| 1 | Titanium oxide | Photo catayist | 20 | 25-90 | PVA |
| 2 | ″ | ″ | 200 | ″ | ″ |
| 3 | ″ | ″ | 20 | ″ | ″ |
| 4 | ″ | ″ | 200 | ″ | ″ |
| 5 | ″ | ″ | 20 | ″ | ″ |
| 6 | ″ | ″ | 200 | ″ | ″ |
| 7 | ″ | ″ | 20 | ″ | ″ |
| 8 | ″ | ″ | 200 | ″ | ″ |
| 9 | ″ | ″ | 20 | ″ | ″ |
| 10 | ″ | ″ | 200 | ″ | ″ |
| 11 | ″ | ″ | 20 | ″ | ″ |
| 12 | ″ | ″ | 200 | ″ | ″ |
| 13 | ″ | ″ | 20 | ″ | ″ |
| 14 | ″ | ″ | 200 | ″ | ″ |
| 15 | ″ | ″ | 200 | ″ | ″ |
| 16 | ″ | ″ | 200 | ″ | ″ |
| 17 | Iron oxide | Electron storage | 80 | ″ | ″ |
| 18 | ″ | ″ | 800 | ″ | ″ |
| 19 | ″ | ″ | 80 | ″ | ″ |
| 20 | ″ | ″ | 800 | ″ | ″ |
| 21 | ″ | ″ | 80 | ″ | ″ |
| 22 | ″ | ″ | 800 | ″ | ″ |
| 23 | ″ | ″ | 80 | ″ | ″ |
| 24 | ″ | ″ | 800 | ″ | ″ |
| 25 | ″ | ″ | 80 | ″ | ″ |
| 26 | ″ | ″ | 800 | ″ | ″ |
| 27 | ″ | ″ | 80 | ″ | ″ |
| 28 | ″ | ″ | 800 | ″ | ″ |
| 29 | ″ | ″ | 80 | ″ | ″ |
| 30 | ″ | ″ | 800 | ″ | ″ |
| 31 | ″ | ″ | 800 | ″ | ″ |
| 32 | ″ | ″ | 800 | ″ | ″ |

TABLE 2

| | | | | Object to | | | |
|---|---|---|---|---|---|---|---|
| | Blowing (spray jet) | | | be treated | | Result | |
| Experiment | | Velocity | Distance* | | Thickness | Film thickness | Provision of |
| No. | Temperature K | m/s | mm | Material | mm | μm | main function |
| 1 | 1590.8 | 1337.5 | 50 | (A) | 6 | (*2) | (*1) |
| 2 | 1469.9 | 1030.5 | 100 | ″ | ″ | ″ | ″ |
| 3 | 1378.5 | 1314.0 | 50 | ″ | ″ | ″ | ″ |
| 4 | 1340.3 | 1109.5 | 100 | ″ | ″ | ″ | ″ |
| 5 | 1191.2 | 1262.0 | 50 | ″ | ″ | ″ | ″ |
| 6 | 1190.1 | 1128.4 | 100 | ″ | ″ | ″ | ″ |
| 7 | 1590.8 | 1337.5 | 50 | ″ | ″ | 5 | ◯ |
| 8 | ″ | ″ | ″ | ″ | ″ | ″ | ″ |
| 9 | 1469.9 | 1030.5 | 100 | ″ | ″ | ″ | ″ |
| 10 | ″ | ″ | ″ | ″ | ″ | ″ | ″ |
| 11 | 1378.5 | 1314.0 | 50 | ″ | ″ | ″ | ″ |
| 12 | ″ | ″ | ″ | ″ | ″ | ″ | ″ |
| 13 | 1340.3 | 1103.5 | 100 | ″ | ″ | ″ | ″ |
| 14 | ″ | ″ | ″ | ″ | ″ | ″ | ″ |
| 15 | 1468.9 | 1030.5 | ″ | (B) | ″ | ″ | ″ |
| 16 | 1340.3 | 1103.5 | ″ | ″ | ″ | ″ | ″ |
| 17 | 1052.7 | 596.1 | 150 | (A) | ″ | (*2) | (*1) |
| 18 | 840.1 | 412.9 | 200 | ″ | ″ | ″ | ″ |
| 19 | 1008.6 | 665.0 | 150 | ″ | ″ | ″ | ″ |
| 20 | 810.0 | 465.3 | 200 | ″ | ″ | ″ | ″ |
| 21 | 956.1 | 718.2 | 150 | ″ | ″ | ″ | ″ |
| 22 | 778.0 | 510.6 | 200 | ″ | ″ | ″ | ″ |
| 23 | 1590.8 | 1337.5 | 50 | ″ | ″ | 5 | ◯ |
| 24 | ″ | ″ | ″ | ″ | ″ | ″ | ″ |
| 25 | 1469.9 | 1030.5 | 100 | ″ | ″ | ″ | ″ |
| 26 | ″ | ″ | ″ | ″ | ″ | ″ | ″ |
| 27 | 1378.5 | 1314.0 | 50 | ″ | ″ | ″ | ″ |
| 28 | ″ | ″ | ″ | ″ | ″ | ″ | ″ |
| 29 | 1340.3 | 1103.5 | 100 | ″ | ″ | ″ | ″ |
| 30 | ″ | ″ | ″ | ″ | ″ | ″ | ″ |
| 31 | 1469.9 | 1030.5 | ″ | (B) | ″ | ″ | ″ |
| 32 | 1340.3 | 1103.5 | ″ | ″ | ″ | ″ | ″ |

Distance*: distance from the top end of the barrel ($$) to the surface of an object to be treated (B)
(*1): since this is for confirming coating condition, main function is not confirmed.
◯: function inherent to fine particles were provided satisfactory.
(*2): coiliding and deposition of powdery particles were confirmed but film thickness was not measured.
(A): 315 stainless steel
(B): SS400 carbon steel

Experiments Nos. 1 to 6 and Experiments Nos. 17 to 22 are for confirming whether the particles can be deposited reliably or not but not for evaluating the function.

Fine particles are obtained by mixing 2 mass % of the binder in the table and pelleting the same by a spray dry method to obtain particles in the table.

For the confirmation of the main function, the photo catalyst function in a case of titanium oxide and the electron storage function in a case of iron oxide are evaluated by the following method.

Photo catalyst function: A coating immersed in an electrolyte and UV-rays are irradiated to the surface thereof. In this state, the electrode potential of the coating is scanned in a positive direction and the value of the flowing current (photo current) is measured. Comparison is made by the level thereof.

Electron storage function: A coating is immersed in an electrolyte, the electrode potential of the coating is scanned in the negative direction, and peak area of the flowing current (charging capacity), and the electrode potential is scanned in the positive direction and the peak area of the flowing current (discharging capacity) is measured. Comparison is made based on the level thereof.

In the confirmation by such evaluation method, influence due to the binder was not found. Since the temperature during spray exceeds the evaporization or sublimation temperature of the binder, it is considered that the most of the binder is evaporized or sublimated by the heating during spraying.

### Example B

Warm spray coating was effected using a particle mixture in which both of the standard particle and the additive particle were formed of titanium.

That is, each of the particles of Experimental Examples 1 to 12 was sprayed as shown in Table 3 by using the apparatus shown in FIG. 1 under the following conditions, thereby confirming the performance thereof.

Fuel (kerosene): 0.30 dm³/min
Oxygen: 0.63 m³/min
Nitrogen: 1.50 m³/min
Distance from gun exit to substrate: 100 mm
Number of pass: 8
Gun moving speed: 700 mm/s
pitch width: 4 mm
N2 (name): 1500 L/min
Particle material: titanium
Material for member as an object: carbon steel
Also the result of evaluation for the denseness of the formed film is shown in Table 3.

In Table 3, Ep, and Rc mean the followings.

Corrosion potential Ep: Steady value for immersion potential of a specimen electrode (titanium coating• carbon steel substrate) to silver• silver chloride reference electrode in artificial sea water.

Corrosion resistance Rc: two sheets of specimen electrodes (titanium coating carbon steel substrate) are opposed to each other and an AC voltage is applied to between both electrodes. The resistance value Rc in corrosion reaction is determined by subtracting the impedance at high frequency (10 kHz) from the impedance at low frequency (100 mHz).

In this case, high Rc value shows that a dense coating is formed. The porosity P has a relation with the value Rc by an electrochemical method. Further, measurement for Rc is more convenient compared with that for the porosity. Rc can be used as a measure for the porosity (denseness).

Further, Pmin (vol %) shows a minimum porosity.

Low porosity P means that the denseness is high. Further, when the porosity reduces to 0%, this means complete denseness. In a general flame sprayed film, the denseness can be considered high when the porosity is 1% or less. In the measuring method, mercury is packed in the pores and the amount thereof is measured as described above. In view of the interpretation on the data, the numerical value cannot but be expressed as this is within a certain range. Then, in Table 3, the minimum porosity Pmin (that is, maximum denseness) is indicated.

Then, in Table 3, Pmin is shown for the highest porosity (Experiment No. 1: comparative example) and for the lowest porosity and the highest denseness (Experiment No. 4: example).

A salt water immersion test was carried out. In the test, a sample was immersed in artificial sea water for 3 days, during which the corrosion potential Ep and the corrosion resistance Rc were measured and denseness of the coating was judged based on the value reaching a steady state after lapse of 24 hours.

TABLE 3

| | Standard particle | | | Additive particle | | | | | Result | | |
|---|---|---|---|---|---|---|---|---|---|---|---|
| Experiment | Particle diameter | | Mass | Particle diameter | | | | | Ep | Rc | Pmin |
| No. | 1) | B | % | 1) | C | D | A | K Value | (mV) | (Ω) | (vol %) |
| 1 (Comparative Example) | 25-45 | 35 | 100 | — | — | — | — | — | 503 | 2220 | 2.3 |
| 2 (Comparative Example) | 25-45 | 35 | 90 | 60-90 | 75 | 3 | 10 | 14 | 432 | 2180 | |
| 3 (Comparative Example) | 25-45 | 35 | 95 | 60-90 | ″ | ″ | 5 | 7 | 465 | 2340 | |
| 4 (Comparative Example) | 25-45 | 35 | 99 | 60-90 | ″ | ″ | 1 | 1.4 | 328 | 13300 | 0.8 |
| 5 (Comparative Example) | 90-150 | 120 | 100 | — | — | — | — | — | 597 | 575 | |
| 6 (Comparative Example) | 25-45 | 35 | 50 | 90-150 | 120 | 6 | 50 | 87.5 | 597 | 575 | |
| 7 (Comparative Example) | 25-45 | 35 | 90 | 90-150 | ″ | ″ | 10 | 17.5 | 572 | 728 | |
| 8 (Comparative Example) | 25-45 | 35 | 95 | 90-150 | ″ | ″ | 5 | 6.75 | 584 | 636 | |
| 9 (Example) | 25-45 | 35 | 99 | 90-150 | ″ | ″ | 1 | 1.75 | 480 | 9330 | |
| 10 (Comparative Example) | 25-45 | 35 | 90 | 45-150 | 97.5 | 105 | 10 | 377 | 552 | 697 | |
| 11 (Comparative Example) | 25-45 | 35 | 95 | 45-150 | ″ | ″ | 5 | 188 | 614 | 1780 | |
| 12 (Comparative Example) | 25-45 | 35 | 99 | 45-150 | ″ | ″ | 1 | 37.7 | 629 | 1620 | |

1) Range for particle diameter (μm)
A: Mass % for the content of additive particle
B: Central particle diameter of standard particle (μm)
C: Central particle diameter of additive particle (μm)
D: (Maximum particle diameter − minimum diameter) of additive particle/10 Power was supplied by a screw feeder.

Experiment No. 4 and Experiment No. 9 in Table 3 are examples of the invention in which the K value is within a range from 1 to 2, and it can be seen that remarkable denseness is obtained.

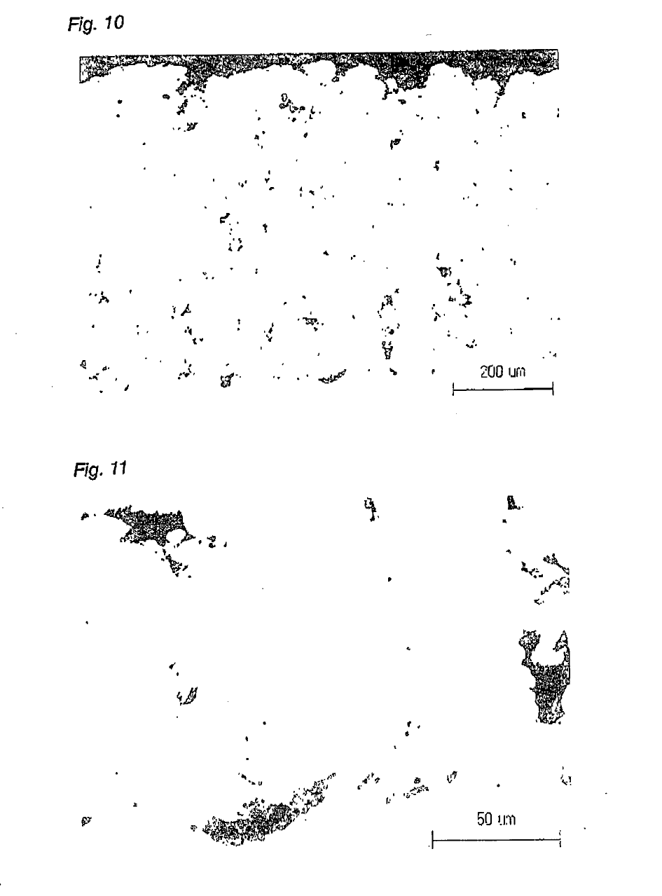

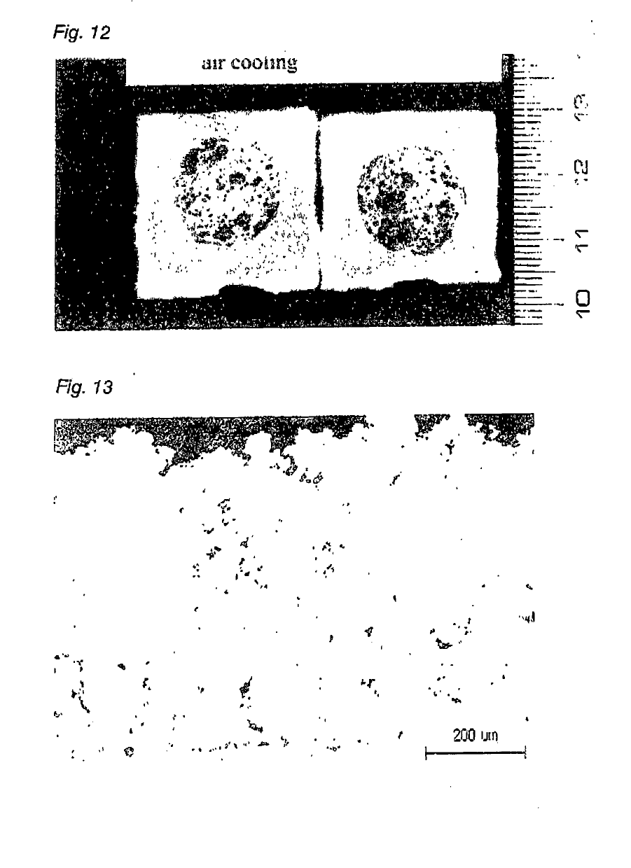

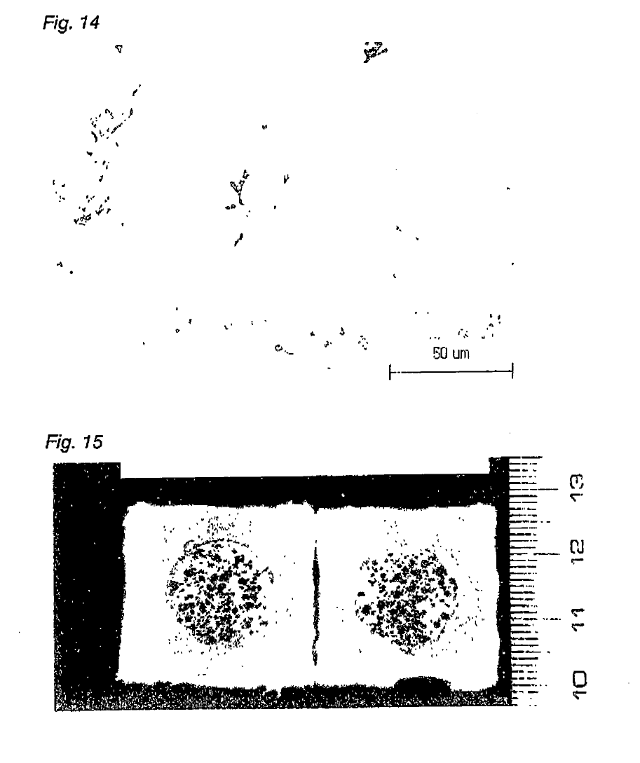

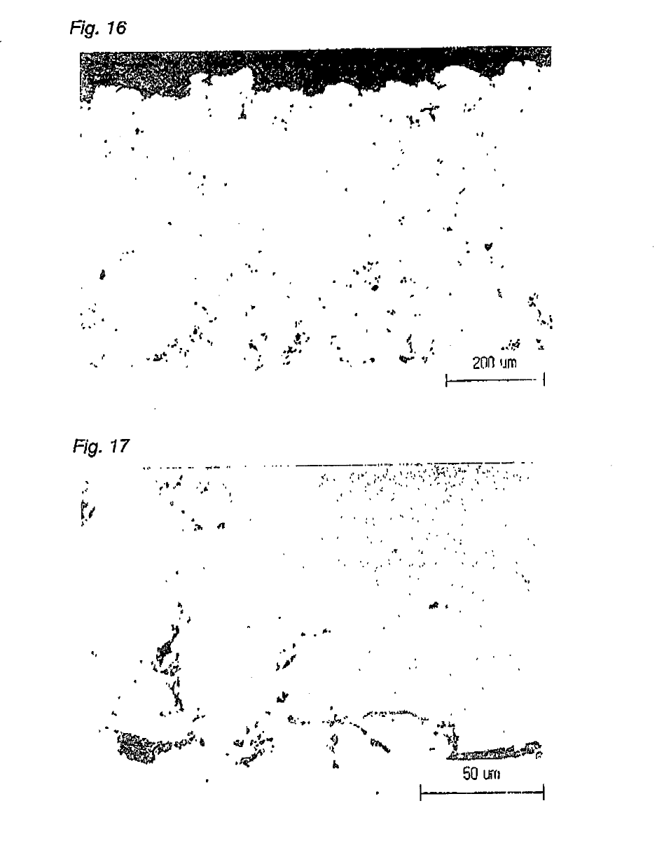

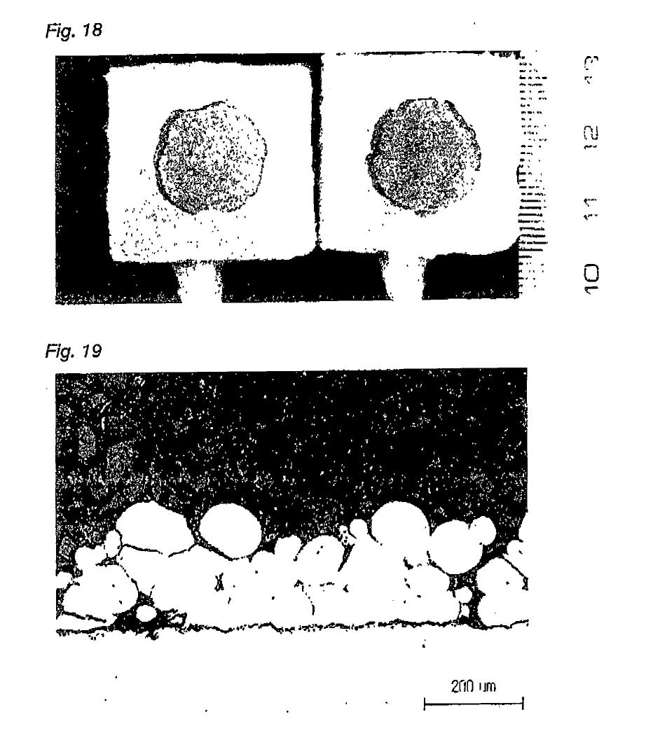

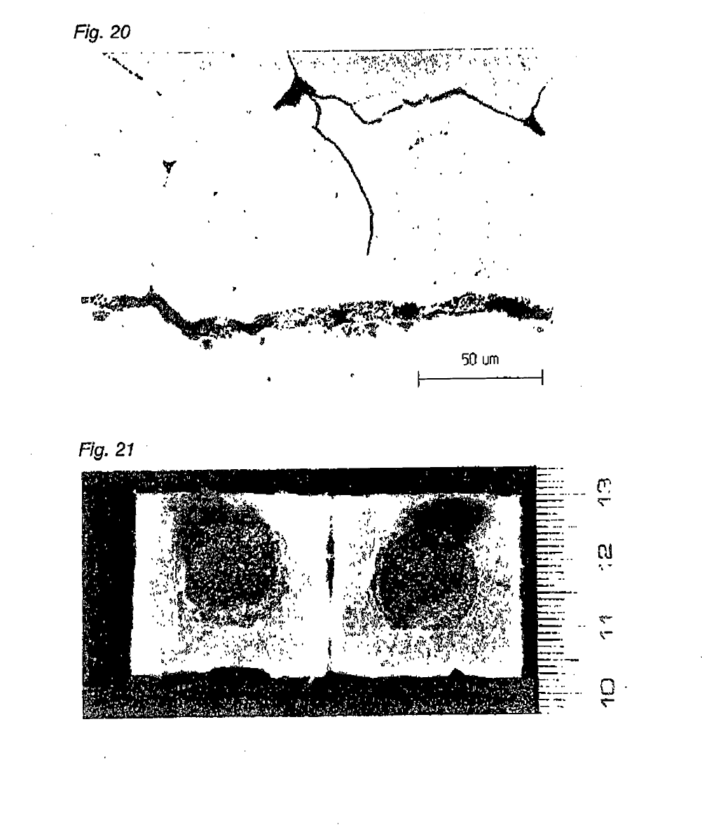

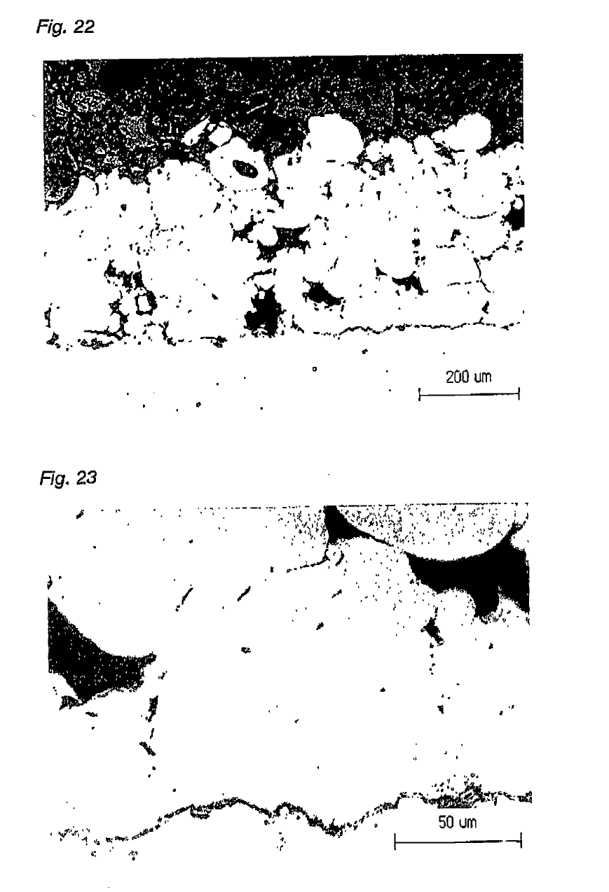

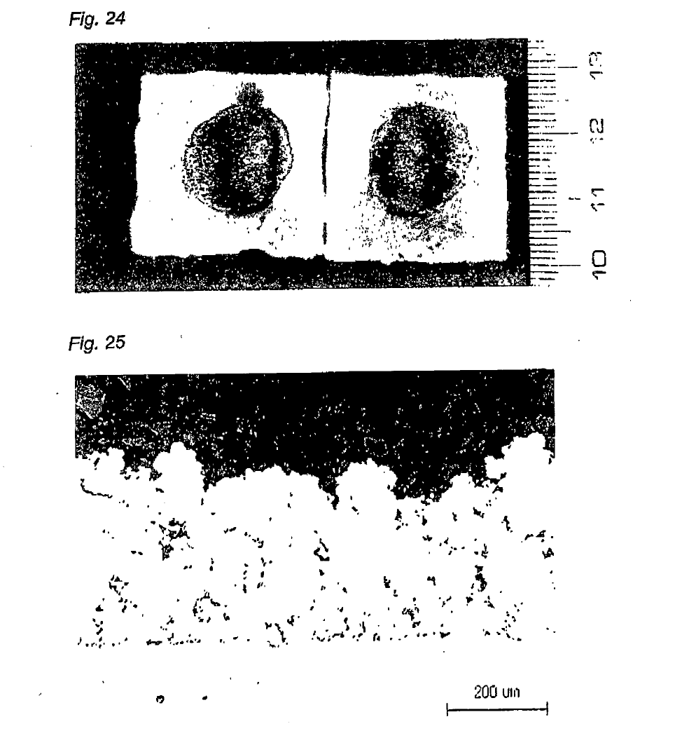

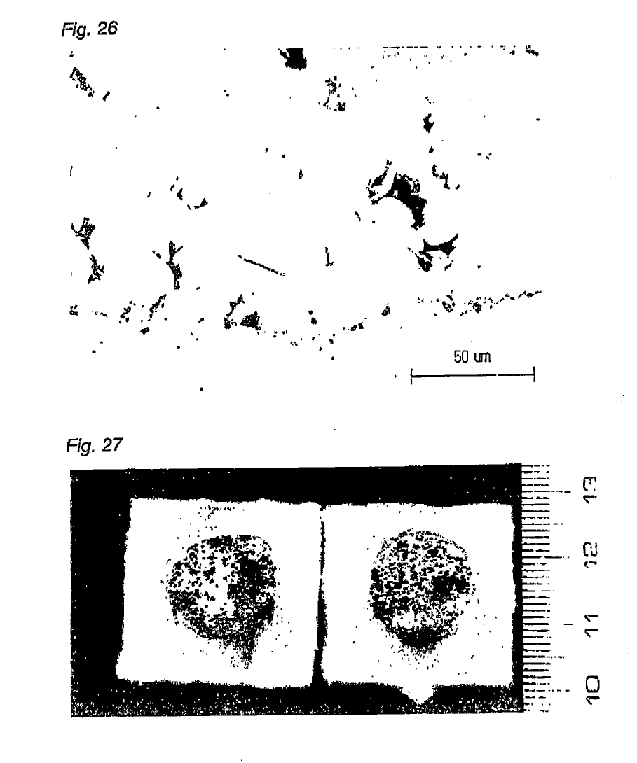

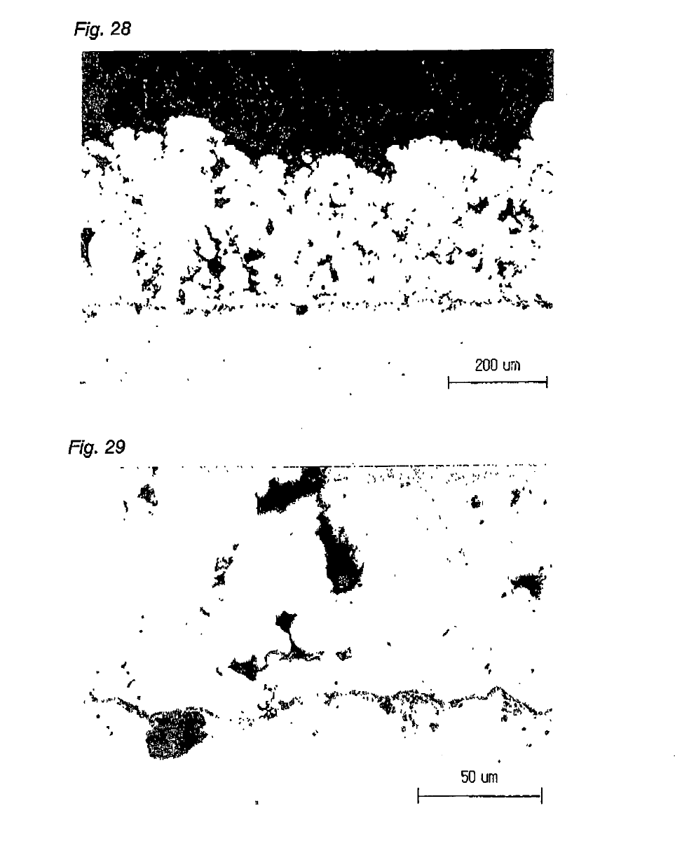

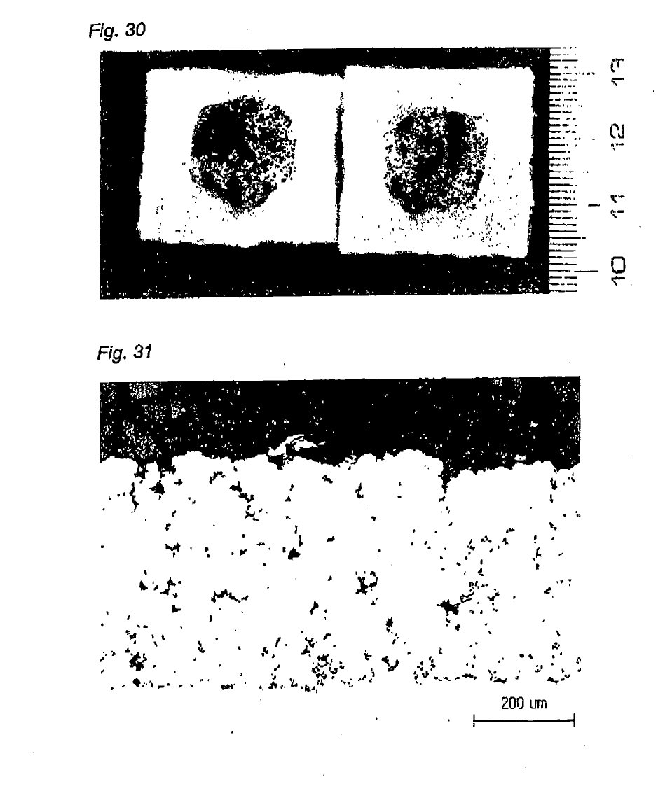

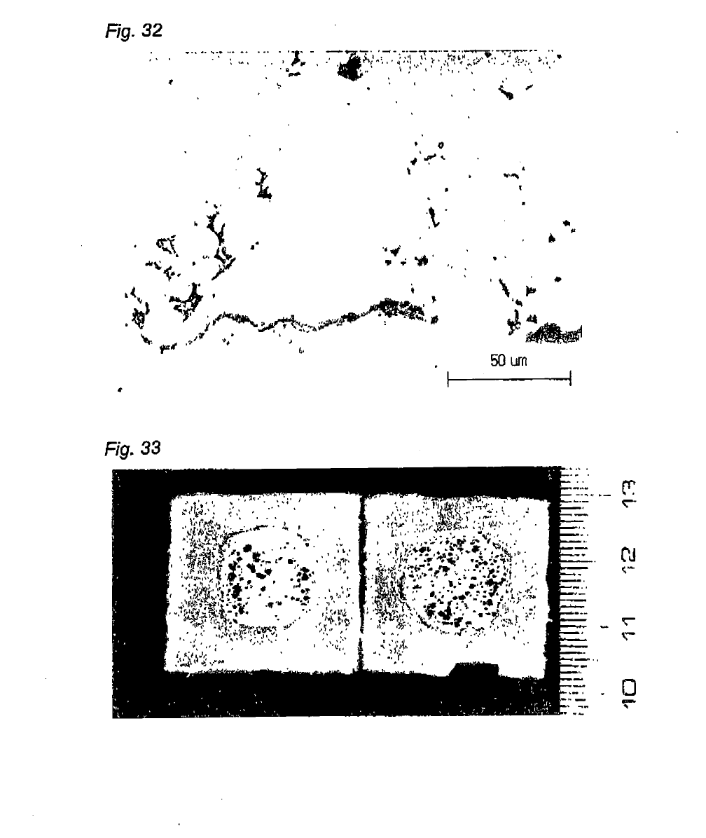

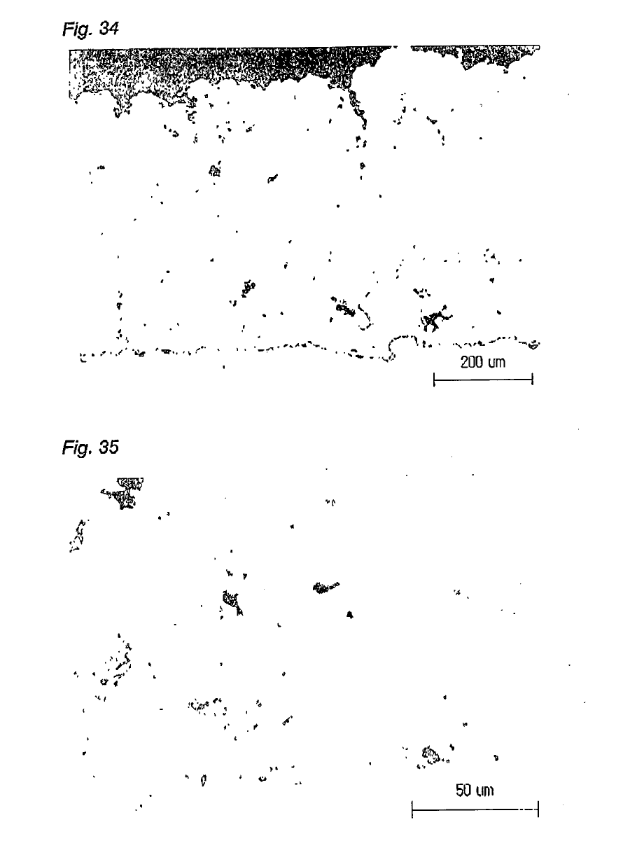

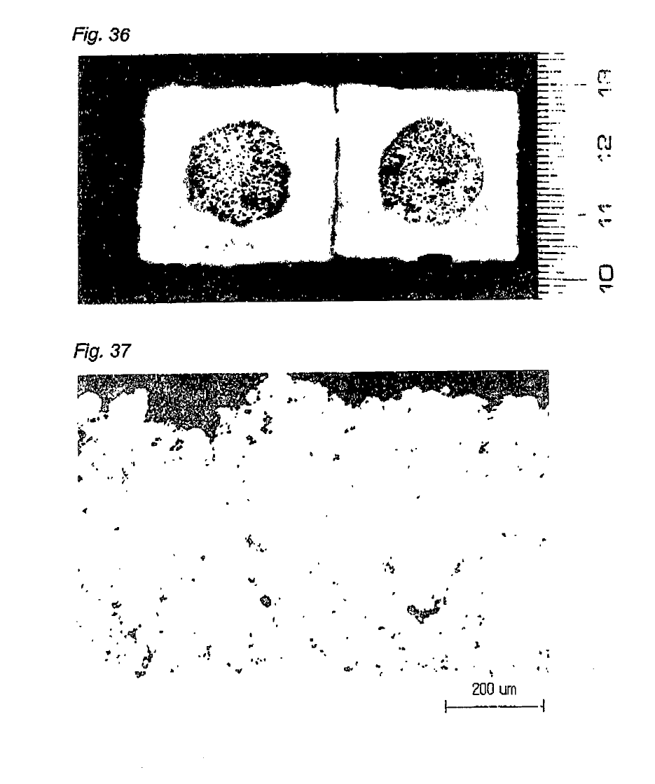

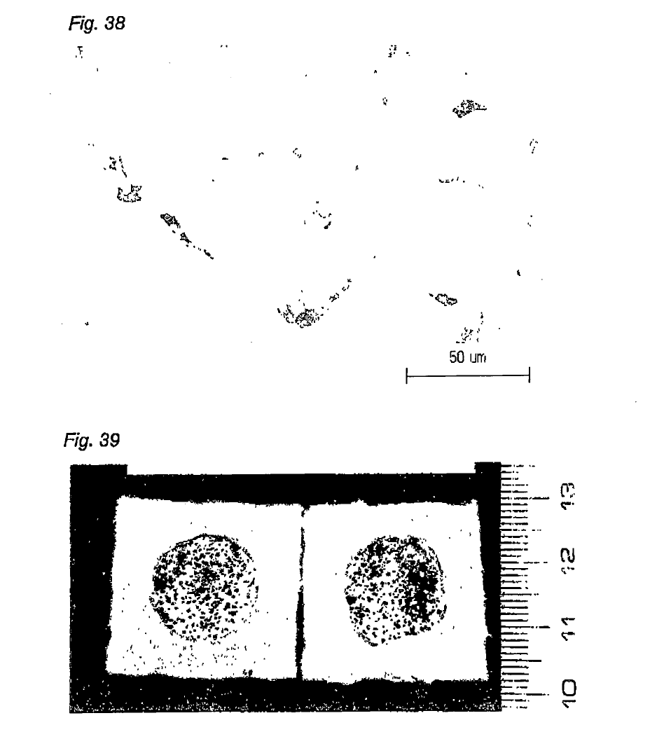

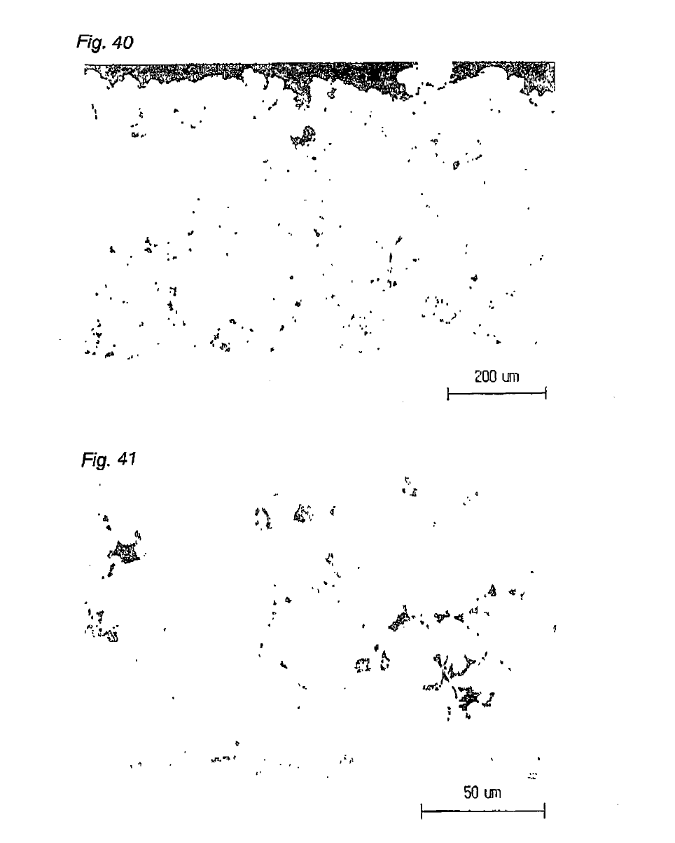

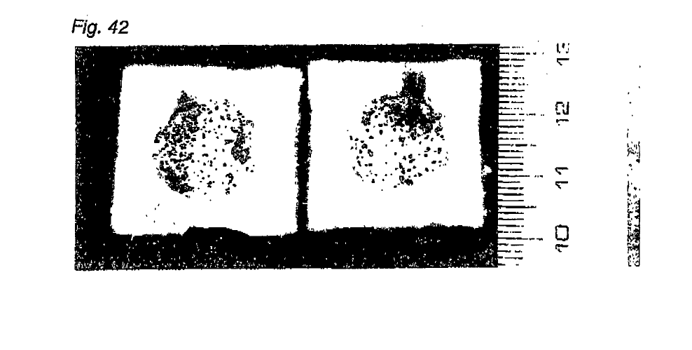

Appended FIG. 7 to FIG. 42 show;

cross sectional photographs of coating layers (FIGS. 7, 10, 13, 16, 19, 22, 25, 28, 31, 34, 37, 40),

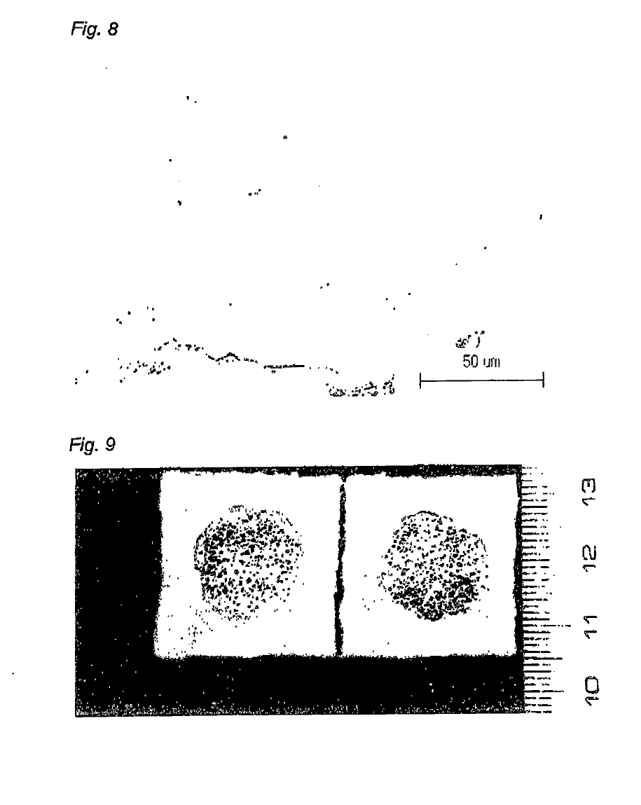

enlarged cross sectional views by 4× of the coating layers (FIGS. 8, 11, 14, 17, 20, 23, 26, 29, 32, 35, 38, 41), and

photographs showing the result of the salt water immersion test of samples (FIGS. 9, 12, 15, 18, 21, 24, 27, 30, 33, 34, 39, 42) for each of specimens in Experiments Nos. 1 to 12.

“Cross sectional photographs and enlarged photographs thereof for coating layers” express the traverse cross section of prepared coatings, in which a lateral line present below is a boundary between carbon steel used as a substrate and a titanium layer as a coating. Further, in the cross section, a black area is a portion where titanium particles are not yet filled and the black portion decreases as the coating becomes more dense. Further, “photographs showing the result of salt water immersion test” show those obtained by applying titanium coating on carbon steel, then leaving a central portion in a circular shape on the surface of the coating and insulatively coating other portions by a silicon resin. This is for measuring whether red rust (appearing black in photograph) derived from carbon steel develops or not at the coating surface thereby confirming whether penetrative pores are present or not in the coating by immersing the same in salt water.

### Example C

Among aggregate particles of 25 to 90 μm of Experiment No. 1 in Table 1, those corresponding to the particle diameter shown for Experiment No. 4 in Table 3 were selected, and a particle mixture of aggregate particles was prepared in the same manner as that shown in Experiment No. 4.

The particles can be selected to a particle diameter in an appropriate range by a vibration sieve device, and the selected particles can be mixed at an optional ratio and supplied to a spray apparatus with no troubles.

They were blown under the same conditions as those in Experiment No. 9 in Table 3.

As a result, not only the same effects as those in Experiment No. 9 could be obtained but also a layer of dense fine particles superior to that of Experiment No. 9 could be obtained, and adhesion strength was strong.

### INDUSTRIAL APPLICABILITY

The coating method of the invention using the aggregate particle comprising fine particles can be used effectively for the coating of a functional material to an object to be treated, for example, in corrosion inhibition of structural steels (bridge peers, inner walls for nuclear reactor core containment vessels, etc.), solar energy conversion-storage devices (solar panels, etc.), purification of atmospheric air contaminants (in express highway guide rails, etc.).

Further, according to the invention of using a mixture of the standard particle and the additive particle, since a dense film is formed, this is optimal to the coating intended for prevention of corrosion of less corrosion resistant materials. Specifically, this is effective for corrosion proof coating for less corrosion resistant materials, for example, structural steels such as bridge peers or building materials, chemical plants such as reaction vessels, various kinds of rolls used, for example, for paper making, metal materials used for biobody in-plants, and sea water heat exchangers.

1-14. (canceled)

15. A warm spray coating method of heating particles and blowing and depositing them at a supersonic velocity to an object to be treated, characterized in that the particle is an aggregate comprising microcrystals with a particle diameter smaller than that of the particles and heated to a temperature lower than the phase transition temperature thereof and blown at a supersonic velocity to an object to be treated.

16. The warm spray coating method according to claim 15, characterized in that the particles are formed by aggregating and solidifying the microcrystals to each other by a binder comprising an organic compound, and the heating temperature upon blowing is at or higher than the sublimation or a vaporization temperature of the binder.

17. The warm spray coating method according to claim 15, characterized in that the microcrystals comprise an oxide crystal.

18. A particle for warm spray coating heated to a temperature lower than the phase transition temperature and blown and deposited to the surface of an object to be treated at a supersonic velocity by a warm spray coating method, characterized in that the fine particle is an aggregate of microcrystals with a smaller particle diameter than that.

19. The particle for warm spray coating according to claim 18, characterized in that the particle is formed by aggregating and solidifying microcrystals to each other by a binder comprising an organic compound, and the sublimation or evaporization temperature of the binder is lower than the heating temperature upon warm spray blowing.

20. The particle for warm spray coating according to according to claim 18, characterized in that the microcrystals comprise an oxide crystal.

21. A warm spray coating method of heating particles to lower than the melting temperature and blowing and depositing them at a supersonic velocity to the surface of an object to be treated, characterized by using, as the particle, a standard particle and an additive particle with a particle diameter larger than that and they are mixed such that the K value determined by the following relation is 1 or more and 2 or less:
K=A×(B/C)×D
A: mass % of the content of additive particle
B: center particle diameter of standard particle (μm)
C: center particle diameter of additive particle (μm)
D: (maximum particle diameter−minimum particle diameter) of additive particles/10 (μm).

22. The warm spray coating method according to claim 21, characterized in that both the standard particle and the additive particle comprise an identical kind of metal particle.

23. The warm spray coating method according to claim 22, characterized in that at least one of the standard particle and the additive particle is an aggregate comprising microcrystals smaller than the particle diameter of each of them.

24. The warm spray coating method according to claim 23, characterized in that the microcrystals constituting the aggregate comprise an oxide crystal.

25. The particle for warm spray coating heated at a temperature lower than the melting point and blown and deposited at a supersonic velocity to the surface of an object to be treated by a warm spray coating method, characterized in that a standard particle and an additive particle having a particle diameter larger than that are mixed such that the K value determined in accordance with the following relation is 1 or more and 2 or less:
K=A×(B/C)×D
A: mass % of the content of additive particle
B: center particle diameter of standard particle (μm)
C: center particle diameter of additive particle (μm)
D: (maximum particle diameter−minimum particle diameter) of additive particles/10 (μm).

26. The particle for warm spray coating method according to claim 25, characterized in that both the standard particle and the additive particle comprise an identical kind of metal particle.

27. The warm spray coating method according to claim 25, characterized in that at least one of the standard particle and the additive particle is a particle of an aggregate comprising microcrystals much smaller than the crystal diameter of each of them.

28. The particle for warm spray coating method according to claim 27, characterized in that the microcrystals constituting the aggregate comprise an oxide crystal.
